(19) United States
(12) Patent Application Publication
(10) Pub. No.: US 2012/0255762 A1
(43) Pub. Date: Oct. 11, 2012

(54) METAL NANOWIRES, METHOD FOR PRODUCING SAME, TRANSPARENT CONDUCTOR AND TOUCH PANEL

(75) Inventors: Kensuke Katagiri, Ashigarakami-gun (JP); Takeshi Hunakubo, Ashigarakami-gun (JP)

(73) Assignee: FUJIFILM CORPORATION, Minato-ku, Tokyo (JP)

(21) Appl. No.: 13/518,288

(22) PCT Filed: Nov. 25, 2010
(86) PCT No.: PCT/JP2010/071028

§ 371 Date: Jun. 21, 2012

(30) Foreign Application Priority Data
Dec. 24, 2009 (JP) 2009-293408

(51) Int. Cl. H01B 5/00; B32B 15/02

(52) U.S. Cl. 174/126.1; 428/606

(57) ABSTRACT

To provide metal nanowires which have high electrical conductivity and excellent heat resistance while maintaining excellent light transmission, a production method thereof, a transparent electrical conductor and a touch panel.

Metal nanowires of the present invention include: silver; and a metal other than silver, wherein the metal nanowires have an average major axis length of 1 μm or more and the metal other than silver is nobler than silver, and wherein when P (atomic %) indicates an amount of the metal other than silver in the metal nanowires and φ (nm) indicates an average minor axis length of the metal nanowires, P and φ satisfy the following expression 1:

0.1<P×φ^{0.5}<30 (Expression 1)
where P is 0.010 atomic % to 13 atomic % and φ is 5 nm to 100 nm.

### TECHNICAL FIELD

The present invention relates to metal nanowires and a production method thereof', and to a transparent electrical conductor and a touch panel.

### BACKGROUND ART

In recent years, various production methods have been investigated to produce an electrical conductive film. Among them, a silver halide method is a method in which a silver halide emulsion is applied on a film, the silver layer is subjected to patternwise light exposure so as to have electrical conductive portions of silver for electrical conductivity and opening portions for providing transparency to thereby produce an electrical conductive film. In addition, a method in which a metallic oxide such as ITO is used in combination is proposed in order to supply electrical power over the entire surface of a film. This method has a problem in that production cost is high because in general, such electrical conductive films are formed by vacuum deposition methods such as vapor deposition, sputtering, and ion plating. In order to lower production cost, an attempt has been made to solve the problem by applying ITO microparticles. However, it is necessary to apply ITO microparticles in large amount to reduce resistance. As a result, transmittance is decreased. Thus, at present, the fundamental problem has not been solved.

There are reports on a transparent electrical conductive film employing silver nanowires and it has been reported that such transparent electrical conductive is satisfactory in terms of transparency, resistance, and reduction in amount of metal used (see, for example, PTL 1). Generally, it is known that metal nanoparticles have melting points lower than those of typical bulk metals. This is because, in the case of nanoparticles, the ratio of the number of atoms exposed to the surface (which have high energy and are unstable) relative to the number of internal atoms is high.

When nanoparticles have shapes other than a wire shape, upon heating, they change their shapes so as to be sphere in order to reduce their surface area to the minimum. In the case of nanowires, breaking of wires sometimes occurs and short wires each change its shape. As a result of wire breaking due to heating, problems such as increase in the resistance of the transparent electrical conductive film and/or loss of conduction occur.

Therefore, in order to provide metal nanowires with heat resistance that is required in the production process of electrical conductivity materials, e.g., in the step of thermo-compression bonding of wiring portions and in the step of attachment using thermoplastic resins, it is necessary to decrease the ratio of surface atoms to internal atoms by making the diameter of the nanowires wider to some degree. Increase in diameter of the nanowires in order to improve heat resistance, however, causes an adverse problem that haze is increased.

As a technique to improve durability of metal nanowires, the following methods are proposed in the patent literatures. PTL 2 proposes a method to protect metal nanowires by plating with a different metal in order to improve oxidation resistance and sulfidation resistance. PTL 3 proposes a method in which a metal forming the metal nanowires is replaced with another metal by reducing an ion of another metal with the atom that forms metal nanowires. In addition, PTL 4 proposes a metal nanowire that includes a silver nanowire and a thin layer on the surface thereof, wherein the thin layer contains at least one metal other than silver. Silver is a material with excellent electrical conductivity and by using metal nanowires containing the same, an electrical conductor with excellent electrical conductivity is obtained.

These methods have certain effects on oxidation resistance and sulfidation resistance, however, it has not been reported that these methods have an effect on heat resistance.

In particular, a plating treatment cannot be applied to patterned transparent electrical conductive layers because of problems such as occurrence of conduction at insulating portions. In plating, a surface of the nanowire is coated with a metal. This increases the diameter of the nanowires and causes another problem that haze is increased.

Metal nanowires of small diameter that are excellent in heat resistance are desired. However, at present, satisfactory metal nanowires of small diameter with such property are not provided.

### CITATION LIST

### Patent Literature

PTL 1: US Patent Application Publication No. 2005/0056118
PTL 2: Japanese Patent Application Laid-Open (JP-A) No. 2009-127092
PTL 3: JP-A No. 2009-215594
PTL 4: JP-A No. 2009-120867

### SUMMARY OF INVENTION

### Technical Problem

The present invention aims to solve the above-mentioned conventional problems and to achieve the following object. An object of the present invention is to provide: metal nanowires which have high electrical conductivity and excellent heat resistance while maintaining excellent light transmission, a production method thereof; a transparent electrical conductor and a touch panel.

### Solution to Problem

Means for solving the above mentioned problems are as follows.

<1> Metal nanowires including:

silver; and

a metal other than silver,

wherein the metal nanowires have an average major axis length of 1 μm or more and the metal other than silver is nobler than silver, and

wherein when P (atomic %) indicates an amount of the metal other than silver in the metal nanowires and φ (nm) indicates an average minor axis length of the metal nanowires, P and φ satisfy the following expression 1:

0.1<P×φ^{0.5}<30 (Expression 1)

where P is 0.010 atomic % to 13 atomic % and φ is 5 nm to 100 nm.

<2> The metal nanowires according to <1>, wherein the metal nobler than silver is at least one of gold and platinum.

<3> The metal nanowires according to <1> or <2>, wherein P (atomic %) and φ (nm) satisfy one of the following relationships (1) to (4):

(1) when φ is 5 nm to 40 nm, P is 0.015 atomic % to 13 atomic %;

(2) when φ is 20 nm to 60 nm, P is 0.013 atomic % to 6.7 atomic %;

(3) when φ is 40 nm to 80 nm, P is 0.011 atomic % to 4.7 atomic %; and

(4) when φ is 60 nm to 100 nm, P is 0.010 atomic % to 3.9 atomic %.

<4> A method for producing the metal nanowires according to any one of <1> to <3>, including:

adding a solution of a salt of a metal other than silver to a silver nanowire dispersion liquid to initiate an oxidation-reduction reaction.

<5> A method for producing the metal nanowires according to any one of <1> to <3>, including:

immersing a coating film of silver nanowire in a solution of a salt of a metal other than silver to initiate an oxidation-reduction reaction.

<6> A transparent electrical conductor including:

a transparent electrical conductive layer,

wherein the transparent electrical conductive layer includes the metal nanowires according to any one of <1> to <3>.

<7> A touch panel including:

the transparent electrical conductor according to <6>.

### Advantageous Effects of Invention

According to the present invention, it is possible to solve the problems in related art and provide metal nanowires which have high electrical conductivity and excellent heat resistance while maintaining excellent light transmission and a production method thereof; and provide a transparent electrical conductor; and a touch panel that include the metal nanowires.

### BRIEF DESCRIPTION OF DRAWINGS

FIGS. 1A and 1B each are an optical microscope picture of metal nanowires of Example 1.

FIGS. 2A and 2B each are an optical microscope picture of metal nanowires of Comparative Example 3.

FIG. 3 is a schematic, cross-sectional view of one exemplary touch panel.

FIG. 4 is a schematic, explanatory view of another exemplary touch panel, where reference character D denotes a driving circuit.

FIG. 5 is a schematic, plan view of one exemplary arrangement of transparent electrical conductors in the touch panel illustrated in FIG. 4.

FIG. 6 is a schematic, cross-sectional view of still another exemplary touch panel.

### DESCRIPTION OF EMBODIMENTS

### (Metal Nanowires)

The metal nanowires of the present invention are metal nanowires that contain silver and a metal other than silver.

The metal other than silver is preferably gold and platinum, which are nobler than silver. Among them, gold is more preferable. These metal materials have higher ionization energy than silver. Thus, it has been known that oxidation resistance can be improved by mixing silver nanowires with the aforementioned metal materials to form an alloy or by plating silver nanowires with the metal materials. The present inventors have newly found that inclusion of the metal material in the silver nanowires in an amount smaller than that used in related art remarkably improves heat resistance of the silver nanowires. One of the possible reasons why a small amount of the metal material improves the heat resistance of the metal nanowires is that the metal materials have a melting point higher than that of silver, but actually the reason why a very small amount of the metal materials causes these effects without covering the entire surface has not been fully understood.

The shape of the metal nanowires is not particularly limited and may be suitably selected according to the intended purpose. They may be any shape such as, for example, cylinders, rectangular cuboids, columns which are polygonal in cross section. The metal nanowires have an average major axis length of 1 μm or greater, preferably 5 μm or greater, more preferably 10 μm or greater.

When the major axis length of the metal nanowires is less than 1 μm, a transparent electrical conductor prepared by coating may experience poor conduction due to a decrease in the number of junction points between metal elements, resulting in high resistance.

The metal nanowires have an average minor axis length, φ (nm), of 5 nm to 100 nm.

When φ is less than 5 nm, even inclusion of the metal material(s) other than silver does not allow the metal nanowires to exhibit a satisfactory heat resistance in some cases. When φ is more than 100 nm, haze is increased due to scattering caused by the metal, potentially degrading the light transmission and the visibility of the transparent electrical conductor that contains the metal nanowires.

In this technique, it is important that the amount of the metal other than silver in the metal nanowires, P (atomic %), i.e., P=100×the number of atoms of the metal other than silver/(the number of atoms of the metal other than silver+the number of silver atom), and the average minor axis length, φ (nm), satisfy the following Expression 1:

0.1<P×φ^{0.5}<30 (Expression 1).

Specifically, the metal nanowires with a minor axis length of φ have excellent heat resistance if the metal other than silver is included in the metal nanowires at the percentage of P that satisfies the above Expression 1. Expression 1 is equivalent to the following Expression 2:

0.01<P²×φ<900 (Expression 2).

In the present application, Expression 1 was adopted in order to avoid the excessively wide range of numerical values. Expression 2, which was obtained approximately based on the experimental values, means larger φ makes it possible to achieve effects of improvement in heat resistance even if P is small. The larger φ is, the smaller the ratio of the surface atoms of the metal atom forming the metal nanowires relative to the atoms inside thereof is. This indicates that improvement in heat resistance of the metal nanowires caused by the metal other than silver can be achieved without inclusion of the metal other than silver in the inside of the metal nanowire if the metal other than silver is present on the surface of the metal nanowires. The term P² or the presence of the square of P probably indicates that what extent replacement treatment contributes to the effect of the improvement of heat resistance is a function of P. In order to improve oxidation resistance, higher surface coverage rate is desired and it is required that the surface is uniformly covered. In the present invention, however, large amount of replacement does not always result in the improvement of heat resistance and uniform coverage of the surface was not needed. When a cation of the metal material, to which silver nanowires are subjected, is reduced by the silver atom of the surface of the silver nanowire, one or more silver atom(s) is/are consumed per one multi-charged ion of the metal material other than silver. Thus, replacement does not result in the increase in the diameter of the nanowires, which is different from the case of plating, and there was no increase in haze to be accompanied with the increase in the diameter. Substantial decrease in the number of atoms forming nanowires does not cause problems if the number of atoms to be replaced is small within the range described in the present application. However, if the number of atoms to be replaced exceeds a certain number, there may be local decrease in wire diameter or breaking of wires may occur. This may result in the decrease in heat resistance and potentially causes decrease in light transmission and increase in the surface resistance of prepared films. Thus, there is an upper limit to the number of the atoms to be replaced. In addition, metals nobler than silver are expensive. This causes another problem that replacement of large number of atoms results in extremely high production cost.

When P×φ^{0.5} is 0.1 or less, the amount of the metal other than silver, to which surface silver atoms are replaced, is inadequate, and in some cases, satisfactory effect of improvement in heat resistance cannot be achieved. When P×φ^{0.5} is 30 or more, heat resistance may be degraded and breaking of metal nanowires may occur.

From the above-mentioned viewpoints, the metal nanowires have a P of 0.010 atomic % to 13 atomic % and a φ of 5 nm to 100 nm.

Further, P (atomic %) varies depending on φ (nm), and P (atomic %) and φ (nm) preferably satisfy one of the following relationships (1) to (4):

(1) when φ is 5 nm to 40 nm, P is preferably 0.015 atomic % to 13 atomic %, more preferably 0.045 atomic % to 4.7 atomic %.

(2) when φ is 20 nm to 60 nm, P is preferably 0.013 atomic % to 6.7 atomic %, more preferably 0.022 atomic % to 3.9 atomic %.

(3) when φ is 40 nm to 80 nm, P is preferably 0.011 atomic % to 4.7 atomic %, more preferably 0.016 atomic % to 3.4 atomic %.

(4) when φ is 60 nm to 100 nm, P is preferably 0.010 atomic % to 3.9 atomic %, more preferably 0.013 atomic % to 3.0 atomic %.

When P and φ satisfy one of the relationships (1) to (4), the metal nanowires exhibit effects of excellent heat resistance more remarkably while maintaining light transmission.

Here, the average length of major axis and minor axis of the metal nanowires can be determined, for example, by using a transmission electron microscope (TEM) and observing TEM images.

The amount of each metal atom in the metal nanowires can be determined, for example, as follows: a measurement sample is dissolved with, for example, an acid, and the resultant sample is measured for the amount of each metal atom using inductively coupled plasma (ICP).

The metal other than silver may be included in the metal nanowire or may cover the metal nanowire, but preferably covers the metal nanowire.

When the metal nanowire is covered with the metal other than silver, the metal other than silver does not necessarily cover the entire surface of the core silver, but it is sufficient if the metal other than silver covers a portion of the entire surface of the core silver.

The average particle diameter (each length of major axis and minor axis) of the metal nanowires and the amount of a metal other than silver in the metal nanowires can be controlled by appropriately selecting the concentrations of metal salts, inorganic salts, and organic acids (or salts thereof); the type of a solvent for particle formation; the concentration of a reducing agent; the addition rate of each reagent; and the temperature, in the production method of the metal nanowires described below.

The metal nanowires preferably have heat resistance as described below. When transparent electrical conductors employing the metal nanowires are used for applications in various devices e.g. in touch panels, antistatic materials for displays, electromagnetic shields, organic or inorganic EL display electrodes, as well as electrodes for flexible displays, antistatic materials for flexible displays, and electrodes for solar cells, the metal nanowires are required to have heat resistance such that metal nanowires can withstand high temperature in the production process of various devices as in the step of attachment using thermoplastic resins (assembling into panels), which is generally performed at 150° C. or more and as in the step of reflow soldering of wiring portions, which is generally performed at 220° C. or more. In order to provide transparent electrical conductors that are reliable in the above-mentioned production process, the metal nanowires preferably have heat resistance against the heating at 240° C. for 30 minutes, particularly preferably have heat resistance against the heating at 240° C. for 60 minutes.

Specifically, it is preferable that the average major axis length of the metal nanowires after heating at 240° C. for 30 minutes under atmosphere is 60% or more of the average major axis length of the metal nanowires before heating, particularly preferable that the average major axis length of the metal nanowires after heating at 240° C. for 60 minutes under atmosphere is 60% or more of the average major axis length of the metal nanowires before heating.

### (Method for Producing Metal Nanowires)

The method for producing metal nanowires of the present invention is a method for producing the metal nanowires of the present invention. In a first embodiment, a solution of a salt of a metal other than silver is added to a silver nanowire dispersion liquid to initiate an oxidation-reduction reaction. In a second embodiment, a coating film of silver nanowire is immersed in a solution containing at least a salt of a metal other than silver to initiate an oxidation-reduction reaction. Metals nobler than silver are used as the metal other than silver. The metal other than silver is preferably one of gold and platinum or both of them. The treatment with a solution of a salt of a metal other than silver may be carried out by both of the addition to a dispersion liquid and the immersion of a coating film in combination. The coating film of silver nanowire can be prepared in the same way as in the “coating dispersion” and in the production of transparent electrical conductor that are described later.

The solvent for the silver nanowire dispersion liquid is not particularly limited and may be suitably selected according to the intended purpose. Examples thereof include water, propanol, acetone, and ethylene glycol. These may be used alone or in combination.

The metal other than silver is preferably generated by the reduction with silver.

The reduction reaction by the addition of a solution of a salt of the metal other than silver proceeds even at room temperature, but is preferably performed while heating a solution containing silver nanowires and a metal salt or a solution of a metal salt in which a coating film of silver nanowire is immersed. Heating of the solution promotes the reduction of the metal salt (Mⁿ⁺→M⁰) due to the oxidation of silver (Ag⁰→Ag⁺). If necessary, photoreduction, addition of a reducing agent, or chemical reduction method may further be used in combination with the heating selected according to the intended purpose.

The heating a solution can be performed by means of, for example, an oil bath, aluminum block heater, hot plate, oven, infrared heater, heat roller, steam (hot air), ultrasonic wave, or microwave. The heating temperature is preferably 35° C. to 200° C., more preferably 45° C. to 180° C.

Examples of the photoreduction include process exposing the solution to ultraviolet ray, visible light, electron beam, and infrared ray.

Examples of the reducing agent used in the addition of a reducing agent include hydrogen gas, sodium borohydride, lithium borohydride, hydrazine, ascorbic acid, amines, thiols, and polyols. For the chemical reduction method, electrolysis may be used.

The metal salt other than silver is not particularly limited and may be suitably selected according to the intended purpose. Examples thereof include nitrate salts, chloride salts, phosphoric salts, sulfate salts, tetrafluoroborates, ammine complexes, chloro complexes, and organic acid salts. Among these, nitrate salts, tetrafluoroborates, ammine complexes, chloro complexes and organic acid salts are particularly preferred, since these show high solubility in water.

The organic acid and organic acids forming the organic acid salts are not particularly limited and may be suitably selected according to the intended purpose. Examples thereof include acetic acid, propionic acid, citric acid, tartaric acid, succinic acid, butyric acid, fumaric acid, lactic acid, oxalic acid, glycolic acid, acrylic acid, ethylenediaminetetraacetic acid, iminodiacetic acid, nitrilotriacetic acid, glycol ether diaminetetraacetic acid, ethylenediaminedipropionic acid, ethylenediaminediacetic acid, diaminopropanol tetraacetic acid, hydroxyethyliminodiacetic acid, nitrilotrimethylenephosphonic acid and bis(2-ethylhexyl)sulfosuccinic acid. These may be used alone or in combination. Among these, organic carboxylic acids and salts thereof are particularly preferable.

Examples of the organic acid salts include alkali metal-organic acid salts and organic acid-ammonium salts, with organic acid-ammonium salts being particularly preferred.

The silver nanowire dispersion contains one of an organic acid and a salt of thereof in an amount of preferably 0.01% by mass to 10% by mass, more preferably 0.05% by mass to 5% by mass of the total solid content. When the amount is less than 0.01% by mass, there may be degradation of dispersion stability. When the amount is greater than 10% by mass, there may be degradation of electrical conductivity and/or durability.

The organic acid (or a salt thereof) content can be measured through, for example, thermogravimetry (TG).

After the oxidation-reduction reaction, metal nanowires that contain silver and the metal other than silver are formed and a dispersion of the metal nanowires can be obtained.

Further, desalination of the dispersion is carried out.

The desalination may be carried out by means of, for example, ultrafiltration, dialysis, gel filtration, decantation or centrifugation after the metal nanowires have been formed.

### —Coating Dispersion—

The dispersion of metal nanowires after the desalination can further be prepared as a coating dispersion.

Specifically, the metal nanowire coating dispersion contains the metal nanowires in a dispersion solvent.

The amount of the metal nanowires in the coating dispersion is not particularly limited, but preferably 0.1% by mass to 99% by mass, and more preferably 0.3% by mass to 95% by mass. When the amount of the metal nanowires in the coating dispersion is less than 0.1% by mass, an excessive amount of load is applied on the metal nanowires in drying during the production process. When the amount of the metal nanowires in the coating dispersion is more than 99% by mass, particles may be easily aggregated.

In this case, in terms of achieving both excellent transparency and electrical conductivity, it is particularly preferable for the coating dispersion to contain metal nanowires having a major axis length of 10 μm or more in an amount of 0.01% by mass or more, more preferably in an amount of 0.05% by mass or more. This allows increased electrical conductivity of the resulting electrical conductor with a smaller coating amount of silver.

The dispersion solvent for the coating dispersion is mostly water and a water-miscible organic solvent can be used in an amount of 50% by volume or less in combination with water.

As the organic solvent, for example, an alcohol compound having a boiling point of 50° C. to 250° C., more preferably 55° C. to 200° C. is suitably used. When such an alcohol compound is used in combination with water, improvement in application of the coating dispersion and reduction of amount of load in drying can be achieved.

The alcohol compound is not particularly limited and may be suitably selected according to the intended purpose. Examples thereof include methanol, ethanol, ethylene glycol, diethylene glycol, triethylene glycol, polyethylene glycol 200, polyethylene glycol 300, glycerin, propylene glycol, dipropylene glycol, 1,3-propanediol, 1,2-butanediol, 1,4-butanediol, 1,5-pentanediol, 1-ethoxy-2-propanol, ethanolamine, diethanolamine, 2-(2-aminoethoxy)ethanol and 2-dimethylaminoisopropanol. Among them, ethanol and ethylene glycol are preferred. These may be used alone or in combination.

Preferably, the coating dispersion does not contain inorganic ions such as alkali metal ions, alkaline earth metal ions and halide ions.

The coating dispersion has an electrical conductivity of preferably 1 mS/cm or less, more preferably 0.1 mS/cm or less, even more preferably 0.05 mS/cm or less. The aqueous dispersion has a viscosity at 20° C. of preferably 0.5 mPa·s to 100 mPa·s, more preferably 1 mPa·s to 50 mPa·s.

If necessary, the coating dispersion may contain various additive(s) such as a surfactant, a polymerizable compound, an antioxidant, an anti-sulfuration agent, a corrosion inhibitor, a viscosity adjuster and/or a preservative.

The corrosion inhibitor is not particularly limited and may be suitably selected according to the intended purpose. Suitable corrosion inhibitor is azoles.

Examples of the azoles include at least one selected from the group consisting of benzotriazole, tolyltriazole, mercaptobenzothiazole, mercaptobenzotriazole, mercaptobenzotetrazole, (2-benzothiazolylthio)acetic acid, 3-(2-benzothiazolylthio)propionic acid, an alkali metal salt thereof, an ammonium salt thereof, and an amine salt thereof. The inclusion of the corrosion inhibitor makes it possible to exhibit an excellent rust-preventing effect. The corrosion inhibitor may be added, in a dissolved state in an appropriate solvent or in powder form, into a coating dispersion or may be provided by producing the after-mentioned transparent electrical conductor and then immersing this conductor in a corrosion inhibitor bath.

The coating dispersion can be suitably used as an aqueous ink for an inkjet printer or dispenser.

A substrate, on which the coating dispersion is applied in image formation by an inkjet printer, includes, for example, paper, coated paper, and a PET film whose surface is coated with, for example, a hydrophilic polymer.

### (Transparent Electrical Conductor)

The transparent electrical conductor of the present invention contains the metal nanowires of the present invention.

The transparent electrical conductor contains at least a transparent electrical conductive layer formed of the coating dispersion. The transparent electrical conductor is, for example, such a transparent electrical conductor that is prepared by applying the coating dispersion on a substrate and drying the coating dispersion.

The substrate is not particularly limited and may be suitably selected according to the intended purpose. Examples of the substrate for a transparent electrical conductor include the following. Among them, a polymer film is preferred, and a poly(ethylene terephthalate) (PET) film and a triacetyl cellulose (TAC) film are particularly preferred in terms of production suitability, lightweight properties, and flexibility. In terms of heat resistance, glass or polymer film with high heat resistance is preferred.

(1) Glasses such as quartz glass, alkali-free glass, crystallized transparent glass, PYREX (registered trademark) glass and sapphire glass
(2) Acrylic resins such as polycarbonates and polymethyl methacrylate; vinyl chloride resins such as polyvinyl chloride and vinyl chloride copolymers; and thermoplastic resins such as polyarylates, polysulfones, polyethersulfones, polyimides, PET, PEN, TAC, fluorine resins, phenoxy resins, polyolefin resins, nylons, styrene resins and ABS resins

### (3) Thermosetting Resins Such as Epoxy Resins

If desired, the substrate materials may be used in combination. Depending on the intended application, substrate materials are appropriately selected from the above-mentioned substrate materials and formed into a flexible substrate such as a film or into a rigid substrate.

The shape of the substrate may be any shape such as disc, card or sheet. The substrate may have a three-dimensionally laminated structure. The substrate may have fine pores or fine grooves having an aspect ratio of 1 or more on the surface where the circuit is to be printed. Into the fine pores or fine grooves, the coating dispersion may be ejected by an inkjet printer or a dispenser.

The surface of the substrate is preferably subjected to hydrophilizing treatment. Also, the surface of the substrate is preferably coated with a hydrophilic polymer. By doing so, the applicability and adhesion of the coating dispersion to the substrate improve.

The hydrophilizing treatment is not particularly limited and may be suitably selected according to the intended purpose. Examples thereof include chemical treatment, mechanical surface-roughening treatment, corona discharge treatment, flame treatment, ultraviolet treatment, glow discharge treatment, active plasma treatment and laser treatment. The surface tension of the surface is preferably made to be 30 dyne/cm or greater by any of these hydrophilizing treatments.

The hydrophilic polymer with which the surface of the substrate is coated is not particularly limited and may be suitably selected according to the intended purpose. Examples thereof include gelatins, gelatin derivatives, caseins, agars, starches, polyvinyl alcohol, polyacrylic acid copolymers, carboxymethyl cellulose, hydroxyethyl cellulose, polyvinylpyrrolidone and dextrans.

The thickness of the hydrophilic polymer layer (when dry) is preferably in the range of 0.001 μm to 100 μm, more preferably 0.01 μm to 20 μm.

The hydrophilic polymer layer is preferably increased in layer strength by the addition of a hardener. The hardener is not particularly limited and may be suitably selected according to the intended purpose. Examples thereof include aldehyde compounds such as formaldehyde and glutaraldehyde; ketone compounds such as diacetyl and cyclopentanedione; vinyl sulfone compounds such as divinyl sulfone; triazine compounds such as 2-hydroxy-4,6-dichloro-1,3,5-triazine; and the isocyanate compounds mentioned in U.S. Pat. No. 3,103,437.

The hydrophilic polymer layer can be formed by dissolving or dispersing any of the above-mentioned compounds in an appropriate solvent such as water so as to prepare a coating solution, and applying the obtained coating solution over the hydrophilized substrate surface by a coating method such as spin coating, dip coating, extrusion coating, bar coating or die coating. If necessary, an underlying layer may be formed between the substrate and the above-mentioned hydrophilic polymer layer for the purpose of further improving adhesion. The drying temperature is preferably 120° C. or lower, more preferably in the range of 30° C. to 100° C.

After the formation of transparent electrical conductor, the formed transparent electrical conductor can be preferably dipped in a corrosion inhibitor bath, and thereby given a more excellent corrosion-inhibiting effect.

In the production process of various devices employing the transparent electrical conductor, the transparent electrical conductor is required to have heat resistance such that the transparent electrical conductor can withstand high temperature in the step of attachment using thermoplastic resins (assembling into panels), which is generally performed at 150° C. or more and in the step of reflow soldering of wiring portions, which is generally performed at 220° C. or more. In order to provide transparent electrical conductors that are reliable in the above-mentioned production process, the transparent electrical conductor preferably has heat resistance against the heating at 240° C. for 30 minutes, particularly preferably has heat resistance against the heating at 240° C. for 60 minutes.

Specifically, it is preferable that the surface resistance of the transparent electrical conductor after heating at 240° C. for 30 minutes under atmosphere does not exceed twice that of the transparent electrical conductor before heating, particularly preferable that the surface resistance of the transparent electrical conductor after heating at 240° C. for 60 minutes under atmosphere does not exceed twice that of the transparent electrical conductor before heating.

### —Application—

The transparent electrical conductor can be widely used, for example, in touch panels, antistatic materials for displays, electromagnetic shields, organic or inorganic EL display electrodes, as well as flexible display electrodes, flexible display antistatic materials, electrodes for solar cells, and various devices.

In particular, the transparent electrical conductor can be suitably used as a transparent electrical conductor of a touch panel. Specifically, when a touch panel is produced from the transparent electrical conductor, the touch panel produced is excellent in visibility by virtue of improvement in transmittance. In addition, by virtue of improvement in electrical conductivity, the touch panel produced therefrom is excellent in response to input of characters or screen touch with at least one of a bare hand, a hand wearing a glove and a pointing tool.

The touch panel includes widely known touch panels. The transparent electrical conductor can be used in touch panels known as so-called touch sensors and touch pads.

### (Touch Panel)

A touch panel of the present invention includes the transparent electrical conductor of the present invention.

The touch panel is not particularly limited, so long as it contains the transparent electrical conductor, and may be appropriately selected depending on the intended purpose. Examples of the touch panel include a surface capacitive touch panel, a projected capacitive touch panel and a resistive touch panel.

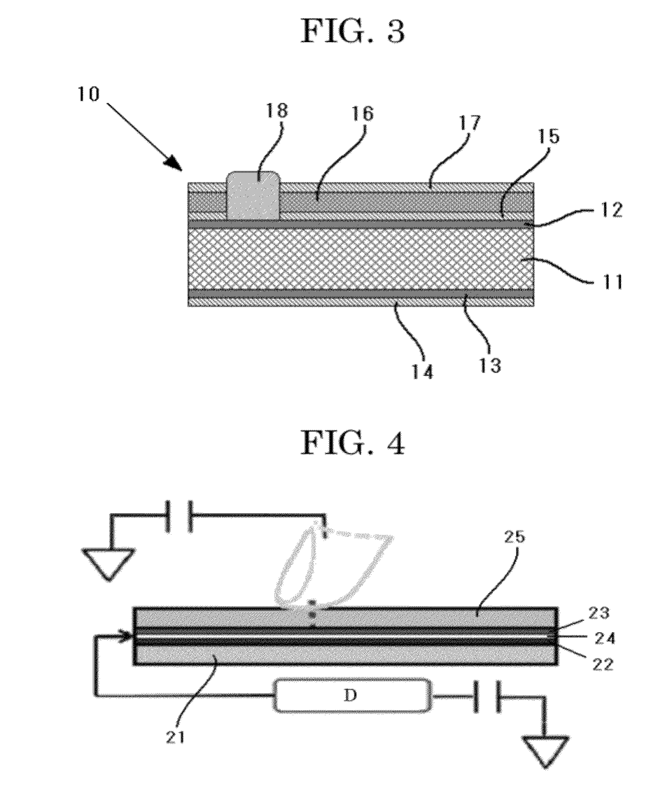

One example of the surface capacitive touch panel will be described with reference to FIG. 3. In FIG. 3, a touch panel 10 includes a transparent substrate 11, a transparent electrical conductive film 12 disposed so as to uniformly cover the surface of the transparent substrate, and an electrode terminal 18 for electrical connection with an external detection circuit (not shown), where the electrode terminal is formed on the transparent electrical conductive film 12 at the end of the transparent substrate 11.

Notably, in this figure, reference numeral 13 denotes a transparent electrical conductive film serving as a shield electrode, reference numerals 14 and 17 each denote a protective film, reference numeral 15 denotes an intermediate protective film, and reference numeral 16 denotes an antiglare film.

For example, when touching any point on the transparent electrical conductive film 12 with a finger, the transparent electrical conductive film 12 is connected at the touched point to ground via the human body, which causes a change in resistance between the electrode terminal 18 and the grounding line. The change in resistance therebetween is detected by the external detection circuit, whereby the coordinate of the touched point is identified.

Another example of the surface capacitive touch panel will be described with reference to FIG. 4. In FIG. 4, a touch panel 20 includes a transparent substrate 21, a transparent electrical conductive film 22, a transparent electrical conductive film 23, an insulating layer 24 and an insulating cover layer 25, where the transparent electrical conductive film 22 and the transparent electrical conductor 23 are disposed so as to cover the surface of the transparent substrate 21. The insulating layer 24 insulates the transparent electrical conductive film 22 from the transparent electrical conductor 23. The insulating cover layer 25 creates capacitance between the transparent electrical conductive film 22 or 23 and a finger coming into contact with the touch panel. In this touch panel, the position of the finger coming into contact with the touch panel is detected. Depending on the intended configuration, the transparent electrical conductive films 22 and 23 may be formed as a single member and also, the insulating layer 24 or the insulating cover layer 25 may be formed as an air layer.

When touching the insulating cover layer 25 with a finger, a change in capacitance is caused between the finger and the transparent electrical conductive film 22 or the transparent electrical conductive film 23. The change in capacitance therebetween is detected by the external detection circuit, whereby the coordinate of the touched point is identified.

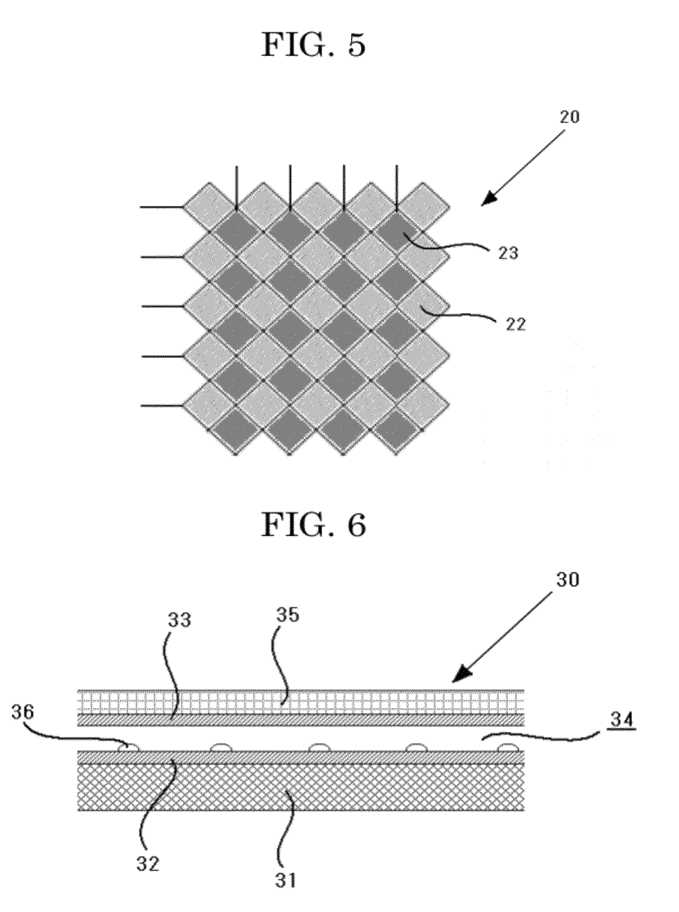

Also, a touch panel 20 as a projected capacitive touch panel will be schematically described with reference to FIG. 5 which is a plan view of the arrangement of transparent electrical conductive films 22 and transparent electrical conductive films 23.

The touch panel 20 includes a plurality of the transparent electrical conductive films 22 capable of detecting the position in the X axis direction and a plurality of the transparent electrical conductive films 23 arranged in the Y axis direction, where these transparent electrical conductive films 22 and 23 are disposed so that they can be connected with external terminals. A plurality of the transparent electrical conductive films 22 and 23 come into contact with the finger, whereby contact information can be input at a plurality of points.

For example, when touching any point on the touch panel 20 with a finger, the coordinates in the X axis direction and the Y axis direction are indentified with high positional accuracy.

Notably, the other members such as a transparent substrate and a protective layer may be appropriately selected from the members of the surface capacitive touch panel. Also, the above-described pattern of the transparent electrical conductive films containing the transparent electrical conductive films 22 and 23 in the touch panel 20 is non-limiting example, and thus the shape and arrangement are not limited thereto.

One example of the resistive touch panel will be described with reference to FIG. 6. In FIG. 6, a touch panel 30 includes a transparent electrical conductive film 32, a substrate 31, a plurality of spacers 36, an air layer 34, a transparent electrical conductive film 33 and a transparent film 35, where the transparent electrical conductive film 32 is disposed on the substrate 31, the spacers 36 are disposed on the transparent electrical conductive film 32, the transparent electrical conductive film 33 can come into contact via the air layer 34 with the transparent electrical conductive film 32, and the transparent film 35 is disposed on the transparent electrical conductive film 33. These members are supported in this touch panel.

When touching the touch panel 30 from the side of the transparent film 35, the transparent film 35 is pressed and the pressed transparent electrical conductive film 32 and the pressed transparent electrical conductive film 33 come into contact with each other. A change in voltage at this point is detected with an external detection circuit (not shown), whereby the coordinate of the touched point is indentified.

### EXAMPLES

The following explains Examples of the present invention. It should, however, be noted that the scope of the present invention is not confined to these Examples.

In Examples and Comparative Examples below, “average particle diameter (length of major axis and minor axis) of metal nanowires” and “amount of a metal other than silver in metal nanowires” were determined as follows.

### <Average Particle Diameter (Length of Major Axis and Minor Axis) of Metal Nanowires>

The average particle diameter of metal nanowires was determined by observing metal nanowires using a transmission electron microscope (TEM) (JEM-2000FX, manufactured by JEOL Ltd.).

<Amount of a Metal Other than Silver in Metal Nanowires>

The amount of silver and a metal other than silver in metal nanowires was measured with ICP (Inductively Coupled Plasma, product of Shimadzu Corporation, ICPS-1000IV).

### Example 1

—Preparation of Additive Solution A—

In 50 mL of purified water, 0.51 g of silver nitrate powder was dissolved. Thereafter, 1N ammonia water was added until the solution became colorless and transparent. Then purified water was added such that the total amount became 100 mL to prepare an additive solution A. A desired amount of additive solution A was prepared by the preparation method.

—Preparation of Additive Solution B—

0.041 g of chloroauric acid tetrahydrate was dissolved in 100 mL of purified water to prepare 1 mM gold solution as an additive solution B. A desired amount of additive solution B was prepared by the preparation method.

—Preparation of Additive Solution C—

0.5 g of glucose powder was dissolved in 140 mL of purified water to prepare an additive solution C. A desired amount of additive solution C was prepared by the preparation method.

—Preparation of Additive Solution D—

0.5 g of HTAB (hexadecyltrimethylammonium bromide) powder was dissolved in 27.5 mL of purified water to prepare an additive solution D. A desired amount of additive solution D was prepared by the preparation method.

—Preparation of Silver Nanowire Dispersion—

Into a three-necked flask, 410 mL of purified water, 82.5 mL of the additive solution D and 206 mL of the additive solution C were added at 27° C. with agitation (first stage).

To the obtained solution, 206 mL of the additive solution A was added at a flow rate of 2.0 mL/min and an agitation rotational speed of 800 rpm (second stage).

Ten minutes afterward, 82.5 mL of the additive solution D was added. Thereafter, the internal temperature was increased to 75° C. at a rate of 3° C./min. After that, the agitation rotational speed was lowered to 200 rpm, and heating was carried out for 5 hours.

The obtained dispersion was cooled. Separately, the ultrafiltration module SIP1013 (molecular weight cut off: 6,000, manufactured by Asahi Kasei Corporation), a magnet pump and a stainless steel cup were connected by a silicone tube to constitute an ultrafiltration apparatus. The silver nanowire dispersion liquid (aqueous solution) was poured into the stainless steel cup, and then ultrafiltration was performed by operating the pump. When the amount of filtrate coming from the module stood at 950 mL, 950 mL of distilled water was poured into the stainless steel cup and washing was carried out by performing ultrafiltration again. The washing was repeated ten times, then concentration was carried out until the amount of mother liquor reached 50 mL, and silver nanowires were thus obtained.

The obtained silver nanowires were observed with a TEM. The average minor axis length and average major axis length of 200 particles were calculated and found to be 31.8 nm and 30.5 μm, respectively.

—Preparation of Metal Nanowire—

A mixed solution of 6.2 mL of additive solution B and 43.8 mL of purified water was added to 50 mL of silver nanowire dispersion under stirring at a flow rate of 2.0 mL/min. After the addition, the mixture was stirred at room temperature for 1 hour and metal nanowires of Example 1 containing 0.10 atomic % of gold were produced.

Metal nanowires of Example 1 were observed with a TEM. The average minor axis length and average major axis length of 200 particles were calculated and found to be 32.5 nm and 29.0 respectively.

The metal nanowires had a product of the amount of gold, P (atomic %), and the square root of the average minor axis length, φ (nm), i.e., P×φ^{0.5} of 0.57.

### Example 2

The same process as in Example 1 was carried out except that the amount of chloroauric acid tetrahydrate, which is dissolved in 100 mL of purified water, in the preparation of additive solution B was changed from 0.041 g to 0.41 g, and metal nanowires of Example 2 containing 1.0 atomic % of gold were produced.

The metal nanowires of Example 2 were observed with a TEM. The average minor axis length and average major axis length of 200 particles were calculated and found to be 32.2 nm and 31.3 respectively.

The metal nanowires had a product of the amount of gold, P (atomic %), and the square root of the average minor axis length, φ (nm), i.e., P×φ^{0.5} of 5.7.

### Example 3

The same process as in Example 1 was carried out except that the amount of chloroauric acid tetrahydrate, which is dissolved in 100 mL of purified water, in the preparation of additive solution B was changed from 0.041 g to 0.0205 g, and metal nanowires of Example 3 containing 0.05 atomic % of gold were produced.

The metal nanowires of Example 3 were observed with a TEM. The average minor axis length and average major axis length of 200 particles were calculated and found to be 32.1 nm and 25.5 respectively.

The metal nanowires had a product of the amount of gold, P (atomic %), and the average minor axis length, φ (nm), i.e., P×φ of 0.28.

### Example 4

The same process as in Example 1 was carried out except that the amount of chloroauric acid tetrahydrate, which is dissolved in 100 mL of purified water, in the preparation of additive solution B was changed from 0.041 g to 2.05 g, and metal nanowires of Example 4 containing 5.0 atomic % of gold were produced.

The metal nanowires of Example 4 were observed with a TEM. The average minor axis length and average major axis length of 200 particles were calculated and found to be 30.7 nm and 30.1 respectively.

The metal nanowires had a product of the amount of gold, P (atomic %), and the square root of the average minor axis length, φ (nm), i.e., P×φ^{0.5} of 28.

### Example 5

The same process as in Example 1 was carried out except that the temperature in the first stage was changed from 27° C. to 20° C. and the amount of chloroauric acid tetrahydrate, which is dissolved in 100 mL of purified water, in the preparation of additive solution B was changed from 0.041 g to 0.41 g, and metal nanowires of Example 5 containing 1.0 atomic % of gold were produced.

The metal nanowires of Example 5 were observed with a TEM. The average minor axis length and average major axis length of 200 particles were calculated and found to be 17.8 nm and 36.7 respectively.

The metal nanowires had a product of the amount of gold, P (atomic %), and the square root of the average minor axis length, φ (nm), i.e., P×φ^{0.5} of 0.42.

### Example 6

The same process as in Example 1 was carried out except that the temperature in the first stage was changed from 27° C. to 40° C. and the amount of chloroauric acid tetrahydrate, which is dissolved in 100 mL of purified water, in the preparation of B was changed from 0.041 g to 1.23 g, and metal nanowires of Example 6 containing 3.0 atomic % of gold were produced.

The metal nanowires of Example 6 were observed with a TEM. The average minor axis length and average major axis length of 200 particles were calculated and found to be 61.1 nm and 25.2 respectively.

The metal nanowires had a product of the amount of gold, P (atomic %), and the square root of the average minor axis length, φ (nm), i.e., P×φ^{0.5} of 23.4.

### Comparative Example 1

The same process as in Example 1 was carried out except that the amount of purified water, to which 0.041 g of chloroauric acid tetrahydrate is dissolved, was changed from 100 mL to 1,000 mL, and metal nanowires of Comparative Example 1 containing 0.010 atomic % of gold were produced.

The metal nanowires of Comparative Example 1 were observed with a TEM. The average minor axis length and average major axis length of 200 particles were calculated and found to be 31.7 nm and 31.2 μm, respectively.

The metal nanowires had a product of the amount of gold, P (atomic %), and the square root of the average minor axis length, φ (nm), i.e., P×φ^{0.5} of 0.056.

### Comparative Example 2

The same process as in Example 1 was carried out except that the amount of chloroauric acid tetrahydrate, which is dissolved in 100 mL of purified water, in the preparation of additive solution B was changed from 0.041 g to 2.88 g, and metal nanowires of Comparative Example 2 containing 8.1 atomic % of gold were produced.

The metal nanowires of Comparative Example 2 were observed with a TEM. The average minor axis length and average major axis length of 200 particles were calculated and found to be 32.1 nm and 28.3 μm, respectively.

The metal nanowires had a product of the amount of gold, P (atomic %), and the square root of the average minor axis length, φ (nm), i.e., P×φ^{0.5} of 46.

### Comparative Example 3

The same process as in Example 1 was carried out except that 6.2 mL of purified water was used instead of 6.2 mL of additive solution B (total amount of purified water added: 50 mL) in the preparation of metal nanowire, and metal nanowires of Comparative Example 3 that do not contain metals other than silver were produced.

The metal nanowires of Comparative Example 3 were observed with a TEM. The average minor axis length and average major axis length of 200 particles were calculated and found to be 30.8 nm and 31.4 respectively.

The metal nanowires had a product of the amount of gold, P (atomic %), and the square root of the average minor axis length, φ (nm), i.e., P×φ^{0.5} of 0.0.

### Comparative Example 4

The same process as in Example 6 was carried out except that 6.2 mL of purified water was used instead of 6.2 mL of additive solution B (total amount of purified water added: 50 mL) in the preparation of metal nanowire, and metal nanowires of Comparative Example 4 that do not contain metals other than silver were produced.

The metal nanowires of Comparative Example 4 were observed with a TEM. The average minor axis length and average major axis length of 200 particles were calculated and found to be 58.2 nm and 22.2 respectively.

The metal nanowires had a product of the amount of gold, P (atomic %), and the square root of the average minor axis length, φ (nm), i.e., P×φ^{0.5} of 0.0.

### (Production of Transparent Electrical Conductors of Examples 1 to 6 and Comparative Examples 1 to 4)

### —Preparation of Metal Nanowire Coating Dispersion—

To each dispersion containing metal nanowires of Examples 1 to 6 and Comparative Examples 1 to 4, was added water, centrifuged, and refined until the conductivity became equal to or lower than 50 μS/cm to prepare a metal nanowire dispersion with a metal content of 22% by mass. All of these metal nanowire dispersions had a viscosity at 25° C. of 10 mPa·s or less. Measurement of viscosity was carried out with VISCOMATE VM-1G (manufactured by CBC Materials Co., Ltd.). Further, hydroxyethyl cellulose was mixed with the metal nanowire dispersions and the amount of the hydroxyethyl cellulose was adjusted so as to be about 50% based on the metal weight to prepare metal nanowire coating dispersions.

Then, using a doctor coater, each of the coating dispersion was applied on a white plate glass (0050-JFL, manufactured by Matsunami Glass Ind., Ltd.) and dried to form a transparent electrical conductive layer containing metal nanowires. Upon coating, the amount of silver and the metal other than silver to be applied was measured with a fluorescent X-ray analyzer (SEA1100, manufactured by Seiko Instruments Inc. (SII)) and coating amount was adjusted to 0.02 g/m².

In this way, transparent electrical conductors of Examples 1 to 6 and Comparative Examples 1 to 4 were produced that correspond to the metal nanowires of Examples 1 to 6 and Comparative Examples 1 to 4.

### (Production of Transparent Electrical Conductor of Example 7)

First, a transparent electrical conductor was prepared using silver nanowires of Comparative Example 3 that does not contain metals other than silver. Then, the obtained transparent electrical conductor was immersed in a 0.1% by mass of aqueous solution of chloroauric acid tetrahydrate for 10 seconds, followed by washing with running water and drying to produce transparent electrical conductor of Example 7 that contains metal nanowires.

The thus-obtained transparent electrical conductor was cut in half and the metal nanowire layer of one of the transparent electrical conductors was dissolved with a concentrated nitric acid and the resulting solution was analyzed with ICP and it was found that the amount of gold in the metal nanowires was 0.07 atomic %. Thus, the metal nanowires had a product of the amount of gold, P (atomic %), and the square root of the average minor axis length, φ (nm), i.e., P×φ^{0.5} of 0.39.

The other half of the transparent electrical conductor was used for the evaluation and measurements described later.

### (Measurement and Evaluation)

### <Durability Test>

Transparent electrical conductors of Examples 1 to 7 and Comparative Examples 1 to 4 were heated at 240° C. for 30 minutes and at 240° C. for 60 minutes using an oven. After the heating, the average major axis length of the metal nanowires of the transparent electrical conductive layer was determined. Based on this result, rates of change in the average major axis length were determined between before and after heating.

The average major axis length of metal nanowires according to each of Examples 1 to 7 and Comparative Examples 1 to 4 was determined as follows. The metal nanowires were observed using field emission-scanning electron microscope (FE-SEM) (S-4300, manufactured by Hitachi High-Technologies Corporation.) and images were taken. The SEM images were examined and the average major axis length was calculated by averaging the major axis lengths of 100 metal nanowires.

Measurements at 240° C. for 30 minutes and at 240° C. for 60 minutes were carried out separately. Specifically, samples were prepared for each measurement and heated continuously using the oven without removing the samples during heating. The results are shown in Table 1 below. Note that when the major axis length after the test is greater than that before the test, the rate of change is described as 100%. This does not indicate the extension of nanowires after the test, but it is speculated that the average major axis length after the test is greater than that before the test because the average value of the major axis lengths vary depending on the places at which SEM images are taken.

TABLE 1

| | | | | | Major axis length | |
|---|---|---|---|---|---|---|
| | Metal nanowires | | | | after test (%) | |
| | | | Amount of the | | After | After |
| | | Minor axis | metal other | | heating | heating |
| | Major axis | length, φ | than silver, P | | for | for |
| | length (μm) | (nm) | (atomic %) | P × φ^{0.5} | 30 min | 60 min |
| Example 1 | 29.0 | 32.5 | 0.1 | 0.57 | 100 | 100 |
| Example 2 | 31.3 | 32.2 | 1.0 | 5.7 | 100 | 100 |
| Example 3 | 25.5 | 32.1 | 0.05 | 0.28 | 88 | 79 |
| Example 4 | 30.1 | 30.7 | 5.0 | 28 | 70 | 64 |
| Example 5 | 36.7 | 17.8 | 0.1 | 0.42 | 76 | 52 |
| Example 6 | 25.2 | 61.1 | 3.0 | 23 | 90 | 92 |
| Example 7 | 31.4 | 30.8 | 0.07 | 0.39 | 100 | 85 |
| Comparative | 31.2 | 31.7 | 0.01 | 0.056 | 9 | 9 |
| Example 1 | | | | | | |
| Comparative | 28.3 | 32.1 | 8.1 | 46 | 39 | 20 |
| Example 2 | | | | | | |
| Comparative | 31.4 | 30.8 | — | 0.0 | 16 | 16 |
| Example 3 | | | | | | |
| Comparative | 22.2 | 58.2 | — | 0.0 | 53 | 20 |
| Example 4 | | | | | | |

### <Surface Resistance>

The surface resistance of the transparent electrical conductive layers in transparent electrical conductors of Examples 1 to 7 and Comparative Examples 1 to 4 was measured and evaluated as follows. The results are shown in Table 2 below.

Specifically, the surface resistance of each material, in which metal nanowires are dispersed, was measured with Loresta-GP MCP-T600 (manufactured by Mitsubishi Chemical Corporation) before heating, and after heating using an oven at 240° C. for 30 minutes and at 240° C. for 60 minutes.

TABLE 2

| | Metal nanowires | | | | Surface resistance (Ω/sq.) | | |
|---|---|---|---|---|---|---|---|
| | | | Amount of the | | | After | After |
| | | Minor axis | metal other | | | heating | heating |
| | Major axis | length, φ | than silver, P | | Before | for | for |
| | length (nm) | (nm) | (atomic %) | P × φ^{0.5} | heating | 30 min | 60 min |
| Example 1 | 29.0 | 32.5 | 0.1 | 0.57 | 15 | 8 | 7 to 12 |
| Example 2 | 31.3 | 32.2 | 1.0 | 5.67 | 40 | 10 to 25 | 16 to 30 |
| Example 3 | 25.5 | 32.1 | 0.05 | 0.28 | 25 | 15 to 38 | 30 to 200 |
| Example 4 | 30.1 | 30.7 | 5.0 | 27.70 | 112 to 153 | 171 to 220 | OL |
| Example 5 | 36.7 | 17.8 | 0.1 | 0.42 | 8 | 12 | 10 |
| Example 6 | 25.2 | 61.1 | 3.0 | 23.45 | 32 | 45 | 80 to 110 |
| Example 7 | 31.4 | 30.8 | 0.07 | 0.39 | 24 | 20 | 31 |
| Comparative | 31.2 | 31.7 | 0.01 | 0.06 | 10 | OL | OL |
| Example 1 | | | | | | | |
| Comparative | 28.3 | 32.1 | 8.1 | 45.89 | OL | OL | OL |
| Example 2 | | | | | | | |
| Comparative | 31.4 | 30.8 | — | 0.00 | 12 | OL | OL |
| Example 3 | | | | | | | |
| Comparative | 22.2 | 58.2 | — | 0.00 | 28 | 300 to 600 | OL |
| Example 4 | | | | | | | |

“OL” mentioned in Table 2 indicates that surface resistance could not be measured due to excessively high resistance of the samples.

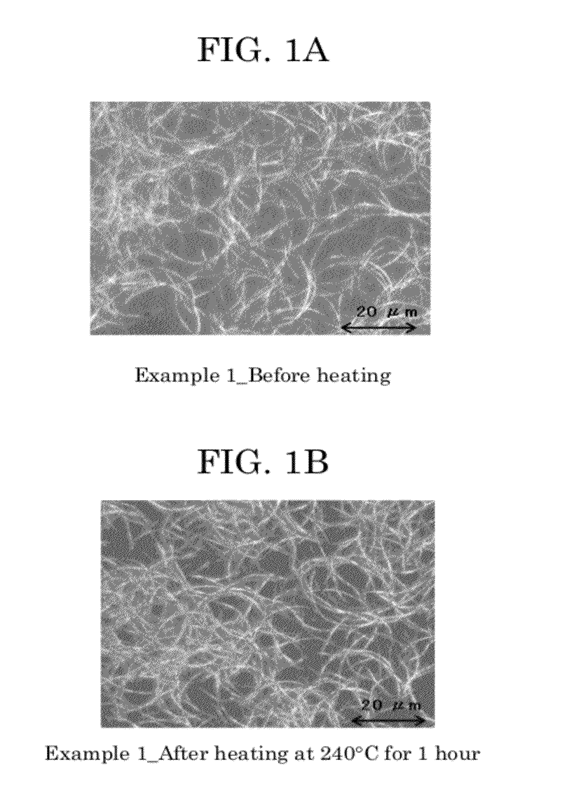

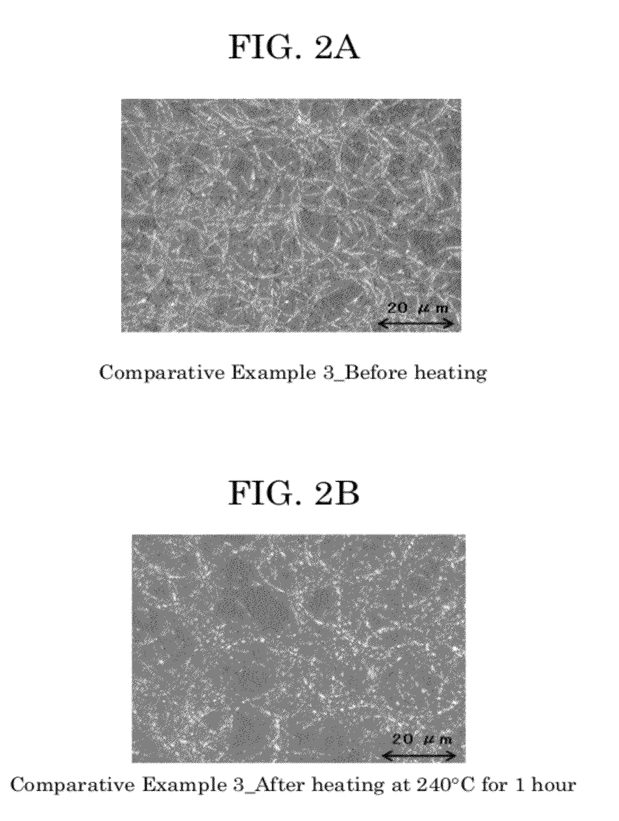

FIGS. 1A and 1B each are an optical microscope picture of metal nanowires of Example 1 and FIGS. 2A and 2B each are an optical microscope picture of metal nanowires of Comparative Example.

As depicted in FIGS. 1A and 1B, comparing metal nanowires of Example 1 before heating and after the heating at 240° C. for 60 minutes, breaking of metal nanowires is not observed, indicating that metal nanowires of Example 1 have extremely high heat resistance. In contrast, as depicted in FIGS. 2A and 2B, comparing metal nanowires of Comparative Example 3 before heating and after the heating at 240° C. for 60 minutes, severe breaking of metal nanowires is observed, indicating that metal nanowires of Comparative Example 3 does not have heat resistance. Thus, transparent electrical conductor of Comparative Example 3 loses conduction between metal nanowires and required electrical conductivity cannot be obtained.

### (Production of Touch Panel)

When a touch panel was produced from the transparent electrical conductor prepared using the metal nanowires described in Example 1, it was found that the touch panel produced was excellent in visibility by virtue of improvement in transmittance. In addition, by virtue of improvement in electrical conductivity, it was also found that the touch panel produced therefrom was excellent in response to input of characters or screen touch with at least one of a bare hand, a hand wearing a glove and a pointing tool. Notably, the touch panel encompasses so-called touch sensors and touch pads.

Also, the touch panels were produced by a known method described in, for example, “Latest Touch Panel Technology (Saishin Touch Panel Gijutsu)” (published on Jul. 6, 2009 from Techno Times Co.), “Development and Technology of Touch Panel (Touch Panel no Gijustu to Kaihatsu),” supervised by Yuji Mitani, published from CMC (2004, 12), FPD International 2009 Forum T-11 Lecture Text Book, Cypress Semiconductor Corporation Application Note AN2292.

### INDUSTRIAL APPLICABILITY

The metal nanowires and metal nanowire dispersed material can be widely used, for example, in touch panels, antistatic material for display, electromagnetic shield, organic or inorganic EL display electrode, as well as flexible display electrodes, flexible display antistatic materials, electrodes for solar cells, and various devices.

### REFERENCE SIGNS LIST

10, 20, 30 Touch panel
11, 21, 31 Transparent substrate
12, 13, 22, 23, 32, 33 Transparent electrical conductive film
24 Insulating layer
25 Insulating cover layer
14, 17 Protective film
15 Intermediate protective film
16 Antiglare film
18 Electrode terminal
33 Spacer
34 Air layer
35 Transparent film
36 Spacer

1-7. (canceled)

8. Metal nanowires comprising:
silver; and
a metal other than silver,
wherein the metal nanowires have an average major axis length of 1 μm or more and the metal other than silver is nobler than silver, and
wherein when P (atomic %) indicates an amount of the metal other than silver in the metal nanowires and φ (nm) indicates an average minor axis length of the metal nanowires, P and φ satisfy the following expression 1:
0.1<P×φ^{0.5}<30 (Expression 1)
where P is 0.010 atomic % to 13 atomic % and φ is 5 nm to 100 nm.

9. The metal nanowires according to claim 8, wherein the metal nobler than silver is at least one of gold and platinum.

10. The metal nanowires according to claim 8, wherein P (atomic %) and φ (nm) satisfy one of the following relationships (1) to (4):
(1) when φ is 5 nm to 40 nm, P is 0.015 atomic % to 13 atomic %;
(2) when φ is 20 nm to 60 nm, P is 0.013 atomic % to 6.7 atomic %;
(3) when φ is 40 nm to 80 nm, P is 0.011 atomic % to 4.7 atomic %; and
(4) when φ is 60 nm to 100 nm, P is 0.010 atomic % to 3.9 atomic %.

11. A transparent electrical conductor comprising:
a transparent electrical conductive layer,
wherein the transparent electrical conductive layer comprises metal nanowires,
wherein the metal nanowires comprise:
silver; and
a metal other than silver,
wherein the metal nanowires have an average major axis length of 1 μm or more and the metal other than silver is nobler than silver, and
wherein when P (atomic %) indicates an amount of the metal other than silver in the metal nanowires and φ (nm) indicates an average minor axis length of the metal nanowires, P and φ satisfy the following expression 1:
0.1<P×φ^{0.5}<30 (Expression 1)
where P is 0.010 atomic % to 13 atomic % and φ is 5 nm to 100 nm.

12. A touch panel comprising:
a transparent electrical conductor,
wherein the transparent electrical conductor comprises:
a transparent electrical conductive layer,
wherein the transparent electrical conductive layer comprises metal nanowires, and
wherein the metal nanowires comprise:
silver; and
a metal other than silver,
wherein the metal nanowires have an average major axis length of 1 μm or more and the metal other than silver is nobler than silver, and
wherein when P (atomic %) indicates an amount of the metal other than silver in the metal nanowires and φ (nm) indicates an average minor axis length of the metal nanowires, P and φ satisfy the following expression 1:
0.1<P×φ^{0.5}<30 (Expression 1)
where P is 0.010 atomic % to 13 atomic % and φ is 5 nm to 100 nm.
